(19) United States
(12) Patent Application Publication
(10) Pub. No.: US 2012/0161674 A1
(43) Pub. Date: Jun. 28, 2012

(54) DC MOTOR SPEED CONTROLLER OF A RANGE HOOD

(76) Inventor: Hsiao-Ping Hung, Fengyuan City (TW)

(21) Appl. No.: 12/977,709

(22) Filed: Dec. 23, 2010

(51) Int. Cl. H02P 6/08

(52) U.S. Cl. 318/4; 318/400.01

(57) ABSTRACT

A DC motor speed controller of a range hood has a motor driving circuit, a DC brushless motor and a monitoring module. The motor driving circuit has a PWM controller and a phase control circuit electrically connected with the pulse width modulation controller. The DC brushless motor is electrically connected to the motor driving circuit. The monitoring module has a microprocessor that generates and transmits a speed control signal to the motor driving circuit so that the motor driving circuit generates a PWM signal to the phase control circuit, the phase control circuit performs a phase modulation and outputs a speed control voltage to the DC brushless motor, and the DC brushless motor varies a speed thereof according to the speed control voltage. Accordingly, the DC motor speed controller of the present invention can drive the DC motor of a range hold with at least four different speeds.

### BACKGROUND OF THE INVENTION

1. Field of the Invention

The present invention relates to a motor speed controller of a range hood, and more particularly to a DC motor speed controller of a range hood.

2. Description of the Related Art

To operate conventional range hoods, users must turn on a range hood fan and adjust speeds of a motor of the fan manually. However, when people are cooking, they are busy with cooking and easily ignore motor speed adjustment to correspond to different cooking procedures. Additionally, people who are cooking lose track of temperature variation inside the range hoods. The motors of the range hood fans are easily damaged when continuously operating at a high temperature for a long duration of time. To solve the problem, range hoods having self-starting and speed-adjustable motors are brought into play, but the motors can only provide three different speeds that are not appropriate and sufficient for actual cooking practices.

### SUMMARY OF THE INVENTION

An objective of the present invention is to provide a DC motor speed controller of a range hood capable of operating at least four different speeds.

To achieve the foregoing objective, the DC motor speed controller of a range hood has an AC to DC conversion circuit, a multi-speed switching unit, a motor driving circuit, a DC brushless motor and a monitoring module.

The AC to DC conversion circuit is adapted to convert an inputted AC power into a DC power to supply an operating power to the range hood.

The multi-speed switching unit has a switch with at least four speed options and selectively switches the switch to output a motor control signal.

The motor driving circuit has a pulse width modulation controller and a phase control circuit. The pulse width modulation controller generates a pulse width modulation signal. The phase control circuit is electrically connected with the pulse width modulation controller, and performs a phase modulation and outputs a speed control voltage according to the received pulse width modulation signal.

The DC brushless motor is electrically connected with the motor driving circuit and varies a speed thereof in accordance with the speed control voltage outputted from the phase control circuit.

The monitoring module has a microprocessor electrically connected to the multi-speed switching unit and the pulse width modulation controller. After receiving the motor control signal transmitted from the multi-speed switching unit, the microprocessor generates a speed control signal in accordance with the motor control signal, and outputs the speed control signal to the motor driving circuit to generate the pulse width modulation signal.

Preferably, the monitoring module further has a sensing module electrically connected with the microprocessor, the motor driving circuit and the DC brushless motor, and having a motor temperature sensing module, a current sensing module and a speed sensing module. The motor temperature sensing module detects temperatures of the DC brushless motor and the motor driving circuit and generates a piece of temperature information included in the sensing signal. The current sensing module detects a consumed current of the DC brushless motor and generates a piece of current information included in the sensing signal. The speed sensing module detects a speed of the DC brushless motor and generates a piece of speed information included in the sensing signal. The microprocessor is embedded with a fault protection procedure, and instructs to slow down or stop the DC brushless motor when determining that any one of the temperature information, current information and speed information in the sensing signal transmitted from the sensing module exceeds a threshold.

Preferably, the sensing module further has a hood temperature sensing module detecting a temperature of the range hood and generating a piece of hood temperature information included in the sensing signal. The microprocessor determines if the hood temperature exceeds an upper bound or drops below a lower bound. If the hood temperature exceeds the upper bound, the microprocessor instructs the DC brushless motor to speed up. If the hood temperature drops below the lower bound, the microprocessor instructs the DC brushless motor to slow down.

The advantages derived from the DC motor speed controller of a range hood of the present invention are as follows:

1. The range hood can be operated with at least four different motor speeds so as to provide a satisfactory smoke venting efficiency based on different cooking conditions.

2. The speed of the DC brushless motor can be adjusted according to a temperature inside the motor, a motor speed, a consumed current and a hood temperature to adapt to an actual cooking condition. Additionally, a fault can be promptly detected and responded to during the operation of the motor. Therefore, operational safety and convenience of the range hood can be further enhanced.

Other objectives, advantages and novel features of the invention will become more apparent from the following detailed description when taken in conjunction with the accompanying drawings.

### BRIEF DESCRIPTION OF THE DRAWINGS

FIG. 1 is a functional block diagram of a DC motor speed controller of a range hood in accordance with the present invention;

FIG. 2 is a partial functional block diagram of the DC motor speed controller of a range hood in FIG. 1; and

FIG. 3 is a perspective view of the DC motor speed controller of a range hood in FIG. 1.

### DETAILED DESCRIPTION OF THE INVENTION

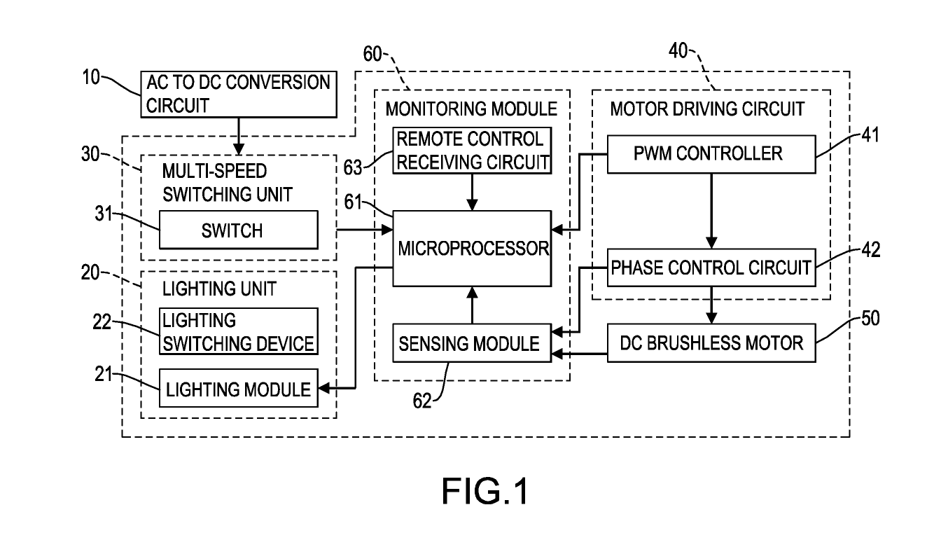

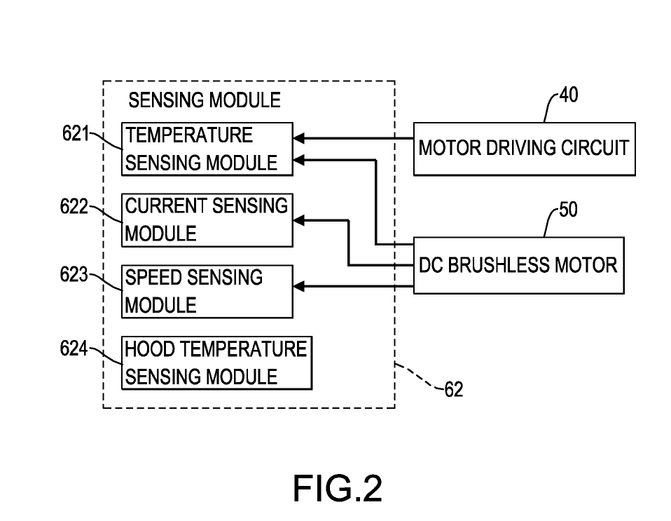

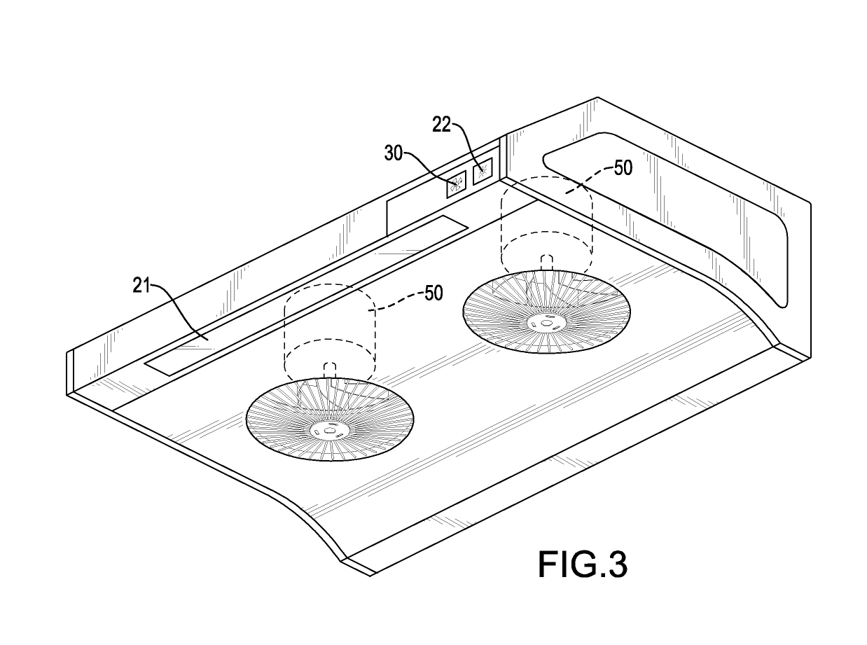

With reference to FIGS. 1 to 3, a DC motor speed controller of a range hood in accordance with the present invention has an AC to DC conversion circuit 10, a lighting unit 20, a multi-speed switching unit 30, a motor driving circuit 40, a DC brushless motor 50 and a monitoring module 60.

The AC to DC conversion circuit 10 serves to convert an AC power into a DC power to supply an operating power to the range hood.

The lighting unit 20 has a lighting module 21 and a lighting switching device 22. The lighting module 21 has LED lamps to provide lighting.

The multi-speed switching unit 30 has a switch 31 with six speed options and selectively switches to a selected speed of the switch 31 to output a corresponding motor control signal.

The motor driving circuit 40 has a pulse width modulation (PWM), a controller 41 and a phase control circuit 42. The PWM controller 41 generates a PWM signal. The phase control circuit 42 is electrically connected with the PWM controller 41, and has a three-phase coil that performs a phase modulation and outputs a three-phase speed control voltage according to the received PWM signal.

The DC brushless motor 50 is electrically connected with the motor driving circuit 40 and varies a speed thereof in accordance with the speed control voltage outputted from the phase control circuit 42 so as to operate at least four different speeds in collaboration with the operation of the multi-speed switching unit 30. In the present embodiment, The DC brushless motor 50 provides six different speeds in collaboration with the operation of the six-speed switch 31.

The monitoring module 60 has a microprocessor 61, a sensing module 62 and a remote control receiving circuit 63. The microprocessor 61 is electrically connected with the lighting switching device 22, the multi-speed switching unit 30 and the PWM controller 41, and is embedded with a fault protection procedure. The sensing module 62 is electrically connected with the motor driving circuit 40 and the DC brushless motor 50 to generate a sensing signal, and has a motor temperature sensing module 621, a current sensing module 622, a speed sensing module 623 and a hood temperature sensing module 624.

The motor temperature sensing module 621 serves to detect temperatures of the DC brushless motor 50 and the motor driving circuit 40 and generate a piece of temperature information included in the sensing signal. The current sensing module 622 serves to detect a consumed current of the DC brushless motor 50 and generate a piece of current information included in the sensing signal. The speed sensing module 623 serves to detect a speed of the DC brushless motor 50 and generate a piece of speed information included in the sensing signal. The hood temperature sensing module 624 serves to detect a temperature of the range hood and generate a piece of hood temperature information included in the sensing signal.

The remote control receiving circuit 63 is electrically connected with the microprocessor 61. After receiving a remote control input, the remote control receiving circuit 63 transmits the remote control input to the microprocessor 61.

The multi-speed switching unit 30 and the lighting switching device 22 are integrated in a touch display that receives an input externally and transmits the input to the microprocessor 61. In response to the input, the microprocessor 61 generates a display signal and transmits the display signal to the touch display to display the corresponding information.

After receiving an external input, the lighting switching device 22 or the remote control receiving circuit 63 transmits the input to the microprocessor 61 to generate a lighting signal in accordance with the input and transmit the lighting signal to the lighting module 21 to provide lighting. After the multi-speed switching unit 30 or the remote control receiving circuit 63 receives the external input and transmits the external input to the microprocessor 61, the microprocessor 61 generates a display signal and transmits the display signal to the touch display for displaying the corresponding information. After receiving the motor control signal from the multi-speed switching unit 30 or the remote control receiving circuit 63, the microprocessor 61 generates a speed control signal according to the motor control signal. After receiving the speed control signal, the motor driving circuit 40 generates the PWM signal according to the speed control signal.

When executing the fault protection procedure, the microprocessor 61 can acquire information of the DC brushless motor 50 and the motor driving circuit 40 detected by the sensing module 62. When determining that any of the temperature information, current information and speed information of the motor transmitted from the sensing module 62 is abnormal, the microprocessor 61 transmits a signal to slow down or stop the DC brushless motor.

The fault protection procedure embedded in the microprocessor 61 is executed as follows.

After the motor temperature sensing module 621 detects a temperature of the DC brushless motor 50 and the motor driving circuit 40, the microprocessor 61 determines if the temperature exceeds a threshold (for example 100) in accordance with the sensing signal including the temperature information and transmitted from the motor temperature sensing module 621. If positive, the microprocessor 61 instructs the DC brushless motor 50 to slow down or stop through the speed control signal.

After the current sensing module 622 detects a consumed current of the DC brushless motor 50, the microprocessor 61 determines if the current exceeds a threshold in accordance with the sensing signal including the current information and transmitted from the current sensing module 622. If positive, the microprocessor 61 instructs the DC brushless motor 50 to slow down through the speed control signal. If the consumed current still exceeds the threshold, the microprocessor 61 further instructs the DC brushless motor 50 to stop through the speed control signal.

After the speed sensing module 623 detects a speed of the DC brushless motor 50, the microprocessor 61 determines if the speed exceeds a threshold in accordance with the sensing signal including the speed information and transmitted from the speed sensing module 623. If the DC brushless motor is stuck and fails to operate, the microprocessor 61 instructs the DC brushless motor 50 to stop through the speed control signal.

After the hood temperature sensing module 624 detects a temperature of the range hood, the microprocessor 61 determines if the hood temperature exceeds an upper bound or drops below a lower bound in accordance with the sensing signal including the hood temperature information and transmitted from the hood temperature sensing module 624. If the hood temperature exceeds the upper bound, indicating that an amount of smoke now is high and the motor speed is not high enough to exhaust the smoke, the microprocessor 61 instructs the DC brushless motor 50 to speed up. If the hood temperature drops below the lower bound, indicating that an amount of smoke now is low and the motor speed is higher than enough to exhaust smoke, the microprocessor 61 instructs the DC brushless motor 50 to slow down for the purpose of saving power.

The DC motor speed controller of the present invention provides at least four speeds so as to make the range hood perform with better smoke venting efficiency. Additionally, the speed of the DC motor can be adjusted and an abnormal operating condition can be immediately detected with regard to the temperature inside the motor, the motor speed, the consumed current of the motor and the hood temperature, thereby enhancing operational safety and convenience of the range hood.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A DC motor speed controller of a range hood, comprising:
an AC to DC conversion circuit adapted to convert an inputted AC power into a DC power to supply an operating power to the range hood;
a multi-speed switching unit having a switch with at least four speed options and selectively switches to a selected speed of the switch to output a motor control signal;
a motor driving circuit having:
a pulse width modulation controller generating a pulse width modulation signal; and
a phase control circuit electrically connected with the pulse width modulation controller, and performing a phase modulation and outputting a speed control voltage according to the received pulse width modulation signal;
a DC brushless motor electrically connected with the motor driving circuit and varying a speed thereof in accordance with the speed control voltage outputted from the phase control circuit; and
a monitoring module having a microprocessor electrically connected to the multi-speed switching unit and the pulse width modulation controller, wherein after receiving the motor control signal transmitted from the multi-speed switching unit, the microprocessor generates a speed control signal, and outputs the speed control signal to the motor driving circuit to generate the pulse width modulation signal.

2. The DC motor speed controller as claimed in claim 1, wherein
the monitoring module further has a sensing module electrically connected with the microprocessor, the motor driving circuit and the DC brushless motor, and having:
a motor temperature sensing module detecting temperatures of the DC brushless motor and the motor driving circuit and generating a piece of temperature information included in the sensing signal;
a current sensing module detecting a consumed current of the DC brushless motor and generating a piece of current information included in the sensing signal; and
a speed sensing module detecting a speed of the DC brushless motor and generating a piece of speed information included in the sensing signal; and
the microprocessor is embedded with a fault protection procedure, and instructs to slow down or stop the DC brushless motor when determining that any one of the temperature information, current information and speed information in the sensing signal transmitted from the sensing module exceeds a threshold.

3. The DC motor speed controller as claimed in claim 1, wherein the sensing module further has a hood temperature sensing module detecting a temperature of the range hood and generating a piece of hood temperature information included in the sensing signal, the microprocessor determines if the hood temperature exceeds an upper bound or drops below a lower bound, if the hood temperature exceeds the upper bound, the microprocessor instructs the DC brushless motor to speed up, if the hood temperature drops below the lower bound, the microprocessor instructs the DC brushless motor to slow down.

4. The DC motor speed controller as claimed in claim 2, wherein the sensing module further has a hood temperature sensing module detecting a temperature of the range hood and generating a piece of hood temperature information included in the sensing signal, the microprocessor determines if the hood temperature exceeds an upper bound or drops below a lower bound, if the hood temperature exceeds the upper bound, the microprocessor instructs the DC brushless motor to speed up, if the hood temperature drops below the lower bound, the microprocessor instructs the DC brushless motor to slow down.

5. The DC motor speed controller as claimed in claim 1, further comprising:
a lighting unit having:
a lighting module; and
a lighting switching device receiving an external input and transmitting the external input to the microprocessor so that the microprocessor generates a lighting signal and transmits the lighting signal to the lighting module to provide lighting.

6. The DC motor speed controller as claimed in claim 2, further comprising:
a lighting unit having:
a lighting module; and
a lighting switching device receiving an external input and transmitting the external input to the microprocessor so that the microprocessor generates a lighting signal and transmits the lighting signal to the lighting module to provide lighting.

7. The DC motor speed controller as claimed in claim 3, further comprising:
a lighting unit having:
a lighting module; and
a lighting switching device receiving an external input and transmitting the external input to the microprocessor so that the microprocessor generates a lighting signal and transmits the lighting signal to the lighting module to provide lighting.

8. The DC motor speed controller as claimed in claim 4, further comprising:
a lighting unit having:
a lighting module; and
a lighting switching device receiving an external input and transmitting the external input to the microprocessor so that the microprocessor generates a lighting signal and transmits the lighting signal to the lighting module to provide lighting.

9. The DC motor speed controller as claimed in claim 5, wherein the multi-speed switching unit and the lighting switching device are integrated in a touch display that receives an input externally and transmits the input to the microprocessor, and the microprocessor generates a display signal and transmits the display signal to the touch display to display information corresponding to the input.

10. The DC motor speed controller as claimed in claim 6, wherein the multi-speed switching unit and the lighting switching device are integrated in a touch display that receives an input externally and transmits the input to the microprocessor, and the microprocessor generates a display signal and transmits the display signal to the touch display to display information corresponding to the input.

11. The DC motor speed controller as claimed in claim 7, wherein the multi-speed switching unit and the lighting switching device are integrated in a touch display that receives an input externally and transmits the input to the microprocessor, and the microprocessor generates a display signal and transmits the display signal to the touch display to display information corresponding to the input.

12. The DC motor speed controller as claimed in claim 8, wherein the multi-speed switching unit and the lighting switching device are integrated in a touch display that receives an input externally and transmits the input to the microprocessor, and the microprocessor generates a display signal and transmits the display signal to the touch display to display information corresponding to the input.

13. The DC motor speed controller as claimed in claim 9, wherein the remote control receiving circuit is electrically connected with the microprocessor, after receiving a remote control input, the remote control receiving circuit transmits the remote control input to the microprocessor, and the microprocessor transmits the speed control signal, the lighting signal and the display signal corresponding to the remote control input.

14. The DC motor speed controller as claimed in claim 10, wherein the remote control receiving circuit is electrically connected with the microprocessor, after receiving a remote control input, the remote control receiving circuit transmits the remote control input to the microprocessor, and the microprocessor transmits the speed control signal, the lighting signal and the display signal corresponding to the remote control input.

15. The DC motor speed controller as claimed in claim 11, wherein the remote control receiving circuit is electrically connected with the microprocessor, after receiving a remote control input, the remote control receiving circuit transmits the remote control input to the microprocessor, and the microprocessor transmits the speed control signal, the lighting signal and the display signal corresponding to the remote control input.

16. The DC motor speed controller as claimed in claim 12, wherein the remote control receiving circuit is electrically connected with the microprocessor, after receiving a remote control input, the remote control receiving circuit transmits the remote control input to the microprocessor, and the microprocessor transmits the speed control signal, the lighting signal and the display signal corresponding to the remote control input.

17. The DC motor speed controller as claimed in claim 13, wherein the phase control circuit has a three-phase coil performing a phase modulation and outputting a three-phase speed control voltage according to the pulse width modulation signal.

18. The DC motor speed controller as claimed in claim 14, wherein the phase control circuit has a three-phase coil performing a phase modulation and outputting a three-phase speed control voltage according to the pulse width modulation signal.

19. The DC motor speed controller as claimed in claim 15, wherein the phase control circuit has a three-phase coil performing a phase modulation and outputting a three-phase speed control voltage according to the pulse width modulation signal.

20. The DC motor speed controller as claimed in claim 16, wherein the phase control circuit has a three-phase coil performing a phase modulation and outputting a three-phase speed control voltage according to the pulse width modulation signal.
